(19) United States
(12) Patent Application Publication
(10) Pub. No.: US 2004/0242762 A1
(43) Pub. Date: Dec. 2, 2004

(54) RTV heat conductive silicone rubber compositions

(76) Inventors: Jun Horikoshi, Usui-gun (JP); Tsuneo Kimura, Usui-gun (JP); Kei Miyoshi, Usui-gun (JP)

Correspondence Address: BIRCH STEWART KOLASCH & BIRCH, PO BOX 747, FALLS CHURCH, VA, 22040-0747, US

(21) Appl. No.: 10/854,278

(22) Filed: May 27, 2004

(30) Foreign Application Priority Data
May 30, 2003 (JP) 2003-155286

(51) Int. Cl. C08L 83/04

(52) U.S. Cl. 524/588

(57) ABSTRACT

A RTV heat conductive silicone rubber composition comprising (A) an organopolysiloxane having hydrolyzable groups at both ends, (B) an organopolysiloxane having at least one hydrolyzable group at one end, (C) a heat conductive filler, and (D) an organosilicon compound having a hydrolyzable group or a partial hydrolytic condensate thereof experiences a minimized viscosity increase even when loaded with a large amount of heat conductive filler (C), has good potting, coating and sealing properties, and is suited for use in one package form.

### TECHNICAL FIELD

This invention relates to room temperature vulcanizable (RTV) heat conductive silicone rubber compositions which undergo only a little viscosity buildup when loaded with large amounts of heat conductive fillers, have good potting, coating and sealing properties, and are suited for use in one package form.

### BACKGROUND OF THE INVENTION

Heat-generating parts such as power transistors and thyristors deteriorate their performance due to the heat generated. It is a common practice in the prior art that such heat-generating parts are provided with heat sinks for heat dissipation or suitable means for conducting heat to a metal chassis of the associated equipment for heat release. To improve both electrical insulation and heat transfer, heat-dissipating, electrically insulating sheets of silicone rubber loaded with heat conductive fillers often intervene between heat-generating parts and heat sinks.

As the heat-dissipating, electrically insulating material, JP-A 47-32400 discloses an electrically insulating composition comprising 100 parts by weight of synthetic rubber, typically silicone rubber and 100 to 800 parts by weight of at least one metal oxide selected from beryllium oxide, aluminum oxide, hydrated aluminum oxide, magnesium oxide, and zinc oxide.

As the heat-dissipating material for use in areas where electrical insulation is not required, JP-A 56-100849 discloses an addition curing type silicone rubber composition comprising 100 parts by weight of a silicone rubber and 60 to 500 parts by weight of silica and a heat conductive powder such as silver, gold or silicon.

These heat conductive materials, however, are very difficult to mold and work in that the liquid silicone rubber compositions lose fluidity if loaded with large amounts of heat conductive fillers in order to improve the heat transfer.

Then U.S. Pat. No. 6,306,957 proposes a heat conductive silicone rubber composition which undergoes only a little viscosity buildup when loaded with large amounts of heat conductive fillers. This composition is of thermosetting type. No reference is made therein to the RTV type.

In electronic machines such as personal computers and CD-ROM drives, IC chips including LSI and CPU are increased in the degree of integration. Since such closely integrated IC chips generate more amounts of heat, conventional cooling means including heat sinks and cooling fans are sometimes unsatisfactory. In particular, lap-top personal computers are difficult to built in large heat sinks or cooling fans because only a limited space is available inside. In such machines, IC chips are mounted on printed circuit boards which use as the substrate glass-reinforced epoxy resins and polyimide resins characterized by poor heat conduction. It is then ineffective to release heat to the substrates through heat-dissipating, electrically insulating sheets as in the prior art.

Then, heat-dissipating parts of air cooling or forced cooling type are disposed in proximity to IC chips so that the heat generated in the chips is conducted to the heat-dissipating parts. When the heat-dissipating part is in close contact with the IC chip, heat transfer is retarded due to surface irregularities. When a heat-dissipating, electrically insulating sheet intervenes between the heat-dissipating part and the IC chip, the less flexibility of the insulating sheet allows the differential thermal expansion between the chip and the part to apply stresses to the chip, posing a possibility of chip failure. Additionally, the attachment of a heat-dissipating part to each circuit chip requires an extra space, preventing size reduction. A system capable of cooling a plurality of IC chips with a single heat-dissipating part is employed in such cases. In particular, CPU's of the TCP type used in lap-top personal computers require deliberate consideration of a cooling system because they have a reduced height, but an increased heat release as compared with ordinary CPU's.

Where semiconductor chips of different heights are arranged with gaps therebetween, a liquid silicone rubber composition capable of filling the varying gaps becomes necessary. As the drive frequency becomes higher, CPU's are developed which have improved performance, but produce larger amounts of heat. A better heat conductive material is desired in this regard too.

An attempt to load a heat conductive liquid silicone rubber composition with a large amount of heat conductive filler for enhancing its heat conductivity results in a composition which loses fluidity and becomes awkward to work.

In the case of addition cure (thermosetting) silicone rubber compositions, a heating means is necessary for curing. A consideration of the heat resistance of IC chips prohibits heating to high temperatures of 60° C. or higher. Additionally, the use of heating means suggests an extra capital investment.

### SUMMARY OF THE INVENTION

Therefore, an object of the invention is to provide a RTV heat conductive silicone rubber composition which is minimized in viscosity increase even when loaded with a large amount of heat conductive filler, has good potting, coating and sealing properties, and is suited for use in one package form.

The inventors have found that blending components (A) and (B) to be defined below results in a RTV heat conductive silicone rubber composition which undergoes only a little viscosity buildup when loaded with a large amount of heat conductive filler, and maintains good potting, coating and sealing properties. The composition is best suited as a heat dissipating material.

The present invention provides a room temperature vulcanizable (RTV) heat conductive silicone rubber composition comprising

(A) 60 to 99 parts by weight of an organopolysiloxane of the general formula (1):

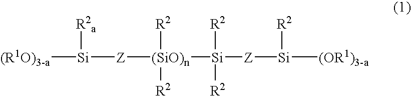

wherein R¹ is hydrogen or a substituted or unsubstituted monovalent hydrocarbon group, R² is a substituted or unsubstituted monovalent hydrocarbon group, Z is an oxygen atom or a divalent hydrocarbon group, a is 0, 1 or 2, and n is an integer of at least 10,

(B) 1 to 40 parts by weight of a hydrolyzable group-containing organopolysiloxane of the general formula (2):

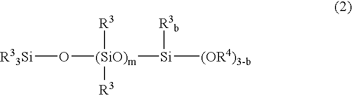

wherein R³ is a substituted or unsubstituted monovalent hydrocarbon group, R⁴ is hydrogen or a substituted or unsubstituted monovalent hydrocarbon group, b is 0, 1 or 2, and m is an integer of 5 to 200, the sum of components (A) and (B) being 100 parts by weight,

(C) 100 to 4,000 parts by weight of a heat conductive filler, and

(D) 1 to 50 parts by weight of an organosilicon compound of the formula: R⁵_{c}SiX_{4-c} wherein R⁵ is a substituted or unsubstituted monovalent hydrocarbon group, X is a hydrolyzable group, and c is 0, 1 or 2, or a partial hydrolytic condensate thereof.

### DESCRIPTION OF THE PREFERRED EMBODIMENTS

Component A

In the RTV heat conductive silicone rubber composition of the invention, component (A) serving as the base is an organopolysiloxane of the following general formula (1).

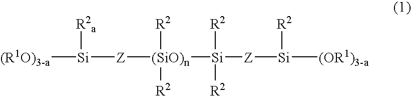

Herein R¹ is hydrogen or a substituted or unsubstituted monovalent hydrocarbon group, R² is a substituted or unsubstituted monovalent hydrocarbon group, Z is an oxygen atom or a divalent hydrocarbon group, a is 0, 1 or 2, and n is an integer of at least 10.

More particularly, R¹ is preferably selected from among hydrogen and substituted or unsubstituted monovalent hydrocarbon groups having 1 to 6 carbon atoms, preferably 1 to 4 carbon atoms, for example, alkyl groups such as methyl, ethyl and propyl, halogenated hydrocarbon groups such as chloromethyl, trichloropropyl and trifluoropropyl, cyano-hydrocarbon groups such as 2-cyanoethyl, 3-cyanopropyl and 2-cyanobutyl, vinyl, allyl, isopropenyl, and phenyl. In the event a=0 or 1, monovalent hydrocarbon groups are preferred, with methyl and ethyl being especially preferred. In the event a=2, hydrogen is preferred.

R² is preferably selected from among substituted or unsubstituted monovalent hydrocarbon groups having 1 to 15 carbon atoms, preferably 1 to 10 carbon atoms, for example, alkyl groups such as methyl, ethyl, propyl, isopropyl, butyl, 2-ethylbutyl and octyl, cycloalkyl groups such as cyclohexyl and cyclopentyl, alkenyl groups such as vinyl and allyl, aryl groups such as phenyl, tolyl, xylyl, naphthyl, biphenylyl and phenanthryl, aralkyl groups such as benzyl and phenylethyl, halogenated hydrocarbon groups such as chloromethyl, trichloropropyl, trifluoropropyl, bromophenyl and chlorocyclohexyl, and cyano-hydrocarbon groups such as 2-cyanoethyl, 3-cyanopropyl and 2-cyanobutyl. Of these, methyl, vinyl, phenyl and trifluoropropyl are preferred, with methyl being especially preferred.

Z is typically an oxygen atom or an alkylene group having 1 to 12 carbon atoms, preferably 1 to 10 carbon atoms such as methylene, ethylene or propylene. Of these, oxygen and ethylene are preferred.

In formula (1), n is an integer of at least 10 such that the organopolysiloxane may have a viscosity at 23° C. of at least 25 mPa·s, preferably 100 to 1,000,000 mPa·s, more preferably 500 to 200,000 mPa·s.

Component B

Component (B) is a diorganopolysiloxane having a hydrolyzable group, represented by the general formula (2).

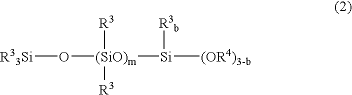

Herein R³ is a substituted or unsubstituted monovalent hydrocarbon group, R⁴ is hydrogen or a substituted or unsubstituted monovalent hydrocarbon group, b is 0, 1 or 2, and m is an integer of 5 to 200.

More particularly, R³ is preferably selected from among unsubstituted monovalent hydrocarbon groups having 1 to 15 carbon atoms, especially 1 to 10 carbon atoms and substituted forms of the foregoing groups in which some hydrogen atoms are substituted with halogen atoms or the like. R³ groups may be the same or different. Examples of R³ include alkyl groups such as methyl, ethyl, propyl, isopropyl, butyl, 2-ethylbutyl and octyl, cycloalkyl groups such as cyclohexyl and cyclopentyl, alkenyl groups such as vinyl and allyl, aryl groups such as phenyl, tolyl, xylyl, naphthyl, biphenylyl and phenanthryl, aralkyl groups such as benzyl and phenylethyl, halogenated hydrocarbon groups such as chloromethyl, trichloropropyl, trifluoropropyl, bromophenyl and chlorocyclohexyl, and cyano-hydrocarbon groups such as 2-cyanoethyl, 3-cyanopropyl and 2-cyanobutyl. Of these, methyl, vinyl and phenyl are preferred, with methyl being especially preferred.

R⁴ is preferably selected from among hydrogen and substituted or unsubstituted monovalent hydrocarbon groups having 1 to 6 carbon atoms, preferably 1 to 4 carbon atoms, for example, alkyl groups such as methyl, ethyl and propyl, halogenated hydrocarbon groups such as chloromethyl, trichloropropyl and trifluoropropyl, cyano-hydrocarbon groups such as 2-cyanoethyl, 3-cyanopropyl and 2-cyanobutyl, vinyl, allyl, isopropenyl, and phenyl. Of these, methyl and ethyl are preferred, with methyl being most preferred.

The subscript b is 0, 1 or 2, preferably 0 or 1, and most preferably 0. The molecule of component (B) is terminated with at least one hydrolyzable group.

In formula (2), m is an integer of 5 to 200. If m is outside the range, the diorganopolysiloxane becomes less effective for reducing the viscosity of the composition.

Component (B) is incorporated in an amount of 1 to 40% by weight, preferably 2 to 35% by weight, more preferably 5 to 30% by weight of the total weight of components (A) and (B). Less than 1% by weight of component (B) is less effective for reducing the viscosity of the composition. If component (B) or hydrolyzable group-containing organopolysiloxane is used in excess of 40% by weight, its effect is saturated, and there is a possibility that the heat conductive filler settles down with the passage of time or the organopolysiloxane bleeds out after curing.

Typical examples of component (B) or hydrolyzable group-containing organopolysiloxane are given below although it is not limited thereto.

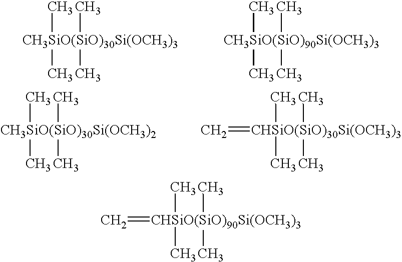

Component C

Component (C) is a heat conductive filler. Use may be made of at least one inorganic powder selected from among aluminum oxide, zinc oxide, ground quartz, silicon carbide, silicon nitride, magnesium oxide, aluminum nitride, boron nitride and graphite, or at least one metal powder selected from among aluminum, copper, silver, nickel, iron and stainless steel. A combination of any of these powders is useful. Aluminum oxide, aluminum nitride and boron nitride are preferred.

With respect to the blending proportion of the organopolysiloxanes as components (A) and (B) and the filler as component (C), 100 to 4,000 parts by weight, preferably 250 to 3,000 parts by weight of component (C) is used per 100 parts by weight of components (A) and (B) combined. Less amounts of component (C) endow the composition with insufficient heat conductivity. Larger amounts of component (C) are difficult to blend and increase the viscosity of the composition to a level to impede working.

The heat conductive filler preferably has a mean particle size of up to 50 μm, more preferably 0.1 to 40 μm and most preferably 0.2 to 30 μm. A filler with a mean particle size in excess of 50 μm is less dispersible so that when a silicone rubber liquid loaded therewith is allowed to stand, the filler will settle out. The heat conductive filler is preferably of a round shape approximate to a sphere. A filler of rounder shape is more effective for preventing a viscosity rise even at high loadings. Such spherical heat conductive fillers are commercially available under the trade name of spherical alumina AS series from Showa Denko K.K. and high purity spherical alumina AO series from Admatechs K.K. In the practice of the invention, it is recommended to combine a heat conductive filler powder fraction having a large mean particle size and a heat conductive filler powder fraction having a small mean particle size in a ratio corresponding to the theoretical closest packing distribution curve. This improves the packing efficiency, achieving a lower viscosity and a higher thermal conductivity. Specifically, a heat conductive filler powder fraction having a mean particle size of less than 5 μm, preferably 0.1 to 3 μm is combined with a heat conductive filler powder fraction having a mean particle size of at least 5 μm, preferably 5 to 40 μm. Their proportion is preferably between 10:90 and 90:10, more preferably between 20:80 and 80:20 in weight ratio.

Component D

The curing agent used herein is a silane having at least two hydrolyzable groups in a molecule, represented by the formula:

R⁵_{c}SiX_{4-c}

wherein R⁵ is a substituted or unsubstituted monovalent hydrocarbon group, X is a hydrolyzable group, and c is 0, 1 or 2, or a partial hydrolytic condensate thereof. More particularly, R⁵ is a substituted or unsubstituted monovalent hydrocarbon group preferably having 1 to 10 carbon atoms, more preferably 1 to 8 carbon atoms, such as methyl, ethyl, propyl, vinyl or phenyl. Suitable hydrolyzable groups represented by X include alkoxy groups such as methoxy, ethoxy and butoxy, ketoxime groups such as dimethylketoxime and methylethylketoxime, acyloxy groups such as acetoxy, alkenyloxy groups such as isopropenyloxy and isobutenyloxy, amino groups such as N-butylamino and N,N-diethylamino, and amide groups such as N-methylacetamide.

The curing agent is used in an amount of 1 to 50 parts by weight per 100 parts by weight of components (A) and (B) combined, i.e., both end hydroxyl or organooxy group-capped organopolysiloxane plus one end hydroxyl or organooxy group-capped organopolysiloxane. Less than 1 part by weight of the curing agent fails to achieve sufficient crosslinking or to produce a composition having desired rubbery elasticity. A composition with more than 50 parts by weight of the curing agent exhibits an increased shrinkage factor upon curing and poor mechanical properties. Preferably the curing agent is used in an amount of 3 to 20 parts by weight.

Curing Catalyst

The silicone rubber composition of the invention is of condensation curing type wherein a curing catalyst is often used. Suitable curing catalysts include alkyltin esters such as dibutyltin diacetate, dibutyltin dilaurate and dibutyltin dioctoate; titanic acid esters or titanium chelate compounds such as tetraisopropoxytitanium, tetra-n-butoxytitanium, tetrakis(2-ethylhexoxy)titanium, dipropoxybis(acetylacetonato)titanium, and titanium isopropoxyoctylene glycol; organometallic compounds such as zinc naphthenate, zinc stearate, zinc 2-ethyloctoate, iron 2-ethylhexoate, cobalt 2-ethylhexoate., manganese 2-ethylhexoate, cobalt naphthenate, and alkoxyaluminum compounds; amonoalkyl-substituted alkoxysilanes such as 3-aminopropyltriethoxysilane and N-β-(aminoethyl)-γ-aminopropyltrimethoxysilane; amine compounds and salts thereof such as hexylamine and dodecylamine phosphate; quaternary ammonium salts such as benzyltriethylammonium acetate; alkali metal salts of lower fatty acids such as potassium acetate, sodium acetate and lithium oxalate; dialkylhydroxylamines such as dimethylhydroxylamine and diethylhydroxylamine; and silanes or siloxanes containing a guanidyl group such as tetramethylguanidylpropyltrimethoxysilane, tetramethylguanidylpropylmethyldimethoxysilane, and tetramethylguanidylpropyltris(trimethylsiloxy)silane, alone or in admixture of any. The curing catalyst is used in an amount of 0 to 10 parts by weight, preferably 0.01 to 5 parts by weight per 100 parts by weight of components (A) and (B) combined.

Filler

In the RTV heat conductive silicone rubber composition of the invention, various other fillers may be compounded, if necessary. Suitable fillers include fumed silica, precipitated silica, diatomaceous earth, metal oxides such as iron oxide and titanium oxide, metal carbonates such as calcium carbonate, magnesium carbonate and zinc carbonate, asbestos, glass wool, carbon black, finely divided mica, fused silica powder, and powdered synthetic resins such as polystyrene, polyvinyl chloride, and polypropylene. The fillers may be compounded in any desired amount as long as the objects of the invention are not impaired. Preferably, the filler has been removed of water by pre-drying, prior to use. In the RTV heat conductive silicone rubber composition of the invention, pigments, dyes, anti-aging agents, antioxidants, antistatic agents, and flame retardants such as antimony oxide and chlorinated paraffin are optionally incorporated.

Additives and Adhesive Aids

Also additives may be added to the inventive composition. Suitable additives include thixotropic agents such as polyethers, mildew-proofing agents, antibacterial agents, and adhesive aids, for example, aminosilanes such as γ-aminopropyltriethoxysilane and 3-(2-aminoethylamino)propyltrimethoxysilane, and epoxysilanes such as γ-glycidoxypropyltrimethoxysilane and β-(3,4-epoxycyclohexyl)ethyltrimethoxysilane.

The RTV heat conductive silicone rubber composition of the invention may be obtained by intimately mixing the aforementioned components (A) to (D) and optionally, curing catalysts, fillers and additives in a dry atmosphere.

The RTV heat conductive silicone rubber composition of the invention remains stable in the sealed state, but when exposed to the air, it quickly cures by the airborne moisture. If necessary, hydrocarbon solvents such as toluene and petroleum ether, ketones or esters may be added to the composition as diluents, prior to use.

The silicone rubber composition of the invention, provided it is diluent-free, has a viscosity at 23° C. of preferably up to 300 Pa·s, more preferably 5 to 300 Pa·s, most preferably 10 to 200 Pa·s.

### EXAMPLE

Examples of the invention are given below by way of illustration and not by way of limitation. All parts are by weight. The viscosity is a measurement at 23° C.

### Examples 1-3 & Comparative Examples 1-2

Component (A) used was a dimethylpolysiloxane capped with hydroxyl groups at both ends of its molecular chain, having a viscosity of 700 mPa·s (23° C.). Component (B) used was a dimethylpolysiloxane containing hydrolyzable groups, represented by the structural formula below.

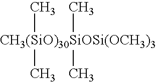

To components (A) and (B) were added 600 parts of spherical aluminum oxide powder AS-30 having a mean particle size of 16 μm (trade name, Showa Denko K.K.) and 300 parts of aluminum oxide powder AL-47-1 having a mean particle size of 1 μm (trade name, Showa Denko K.K.) as component (C). They were mixed at room temperature for 20 minutes on a Shinagawa mixer. This mixture was combined with 16 parts of phenyltri(isopropenyloxy)silane as component (D), 0.8 part of 1,1,3,3-tetramethyl-2-[3-(trimethoxysilyl)propyl]guanidine-siloxane as a curing catalyst, and 1 part of 3-aminopropyltriethoxysilane as an adhesive aid in an anhydrous state. This was followed by deaerating/mixing treatment for 20 minutes, obtaining a composition. The amounts of components (A) and (B) used are shown in Table 1.

The low-viscosity, heat conductive silicone rubber compositions prepared as above were cured at 23±2° C. and 50±5% RH for 7 days into sheets of 6 mm thick. They were measured for hardness using a Durometer type A hardness meter.

Separately, the compositions were cured at 23±2° C. and 50±5% RH for 14 days into blocks of 12 mm thick, which were measured for thermal conductivity using a thermal conductivity meter Kemtherm QTM-D3 (quick thermal conductivity meter by Kyoto Electronic Industry K.K.). To examine storage stability, 100 g of each composition sample was contained in a glass bottle where it was allowed to stand at 23° C. for 1,000 hours. The sample was rated NG when component (C) settled out and OK when no settlement was observed.

The results are shown in Table 1.

TABLE 1

| | | | | | Comparative | |
|---|---|---|---|---|---|---|
| | | Example | | | Example | |
| | | 1 | 2 | 3 | 1 | 2 |
| Compo- | Component A | 95 | 90 | 70 | 50 | 100 |
| nents | Component B | 5 | 10 | 30 | 50 | 0 |
| (pbw) | Component C | 900 | 900 | 900 | 900 | 900 |
| | Component D | 16 | 16 | 16 | 16 | 16 |
| | Curing catalyst | 0.8 | 0.8 | 0.8 | 0.8 | 0.8 |
| | Adhesive aid | 1 | 1 | 1 | 1 | 1 |
| Prop- | Viscosity | 100 | 80 | 76 | 61 | 360 |
| erties | (Pa · s) | | | | | |
| | Hardness | 90 | 90 | 87 | 82 | 90 |
| | (Durometer | | | | | |
| | type A) | | | | | |
| | Heat | 2.5 | 2.4 | 2.4 | 2.5 | 2.4 |
| | conductivity | | | | | |
| | (W/m · K) | | | | | |

| | | | | | |
|---|---|---|---|---|---|
| Storage stability | OK | OK | OK | NG | OK |

The results in Table 1 indicate that the addition of component (B) enables a viscosity reduction, ensuring a composition which is flowable and easy to work.

### Examples 4-6 & Comparative Examples 3-4

Component (A) used was a dimethylpolysiloxane capped with hydroxyl groups at both ends of its molecular chain, having a viscosity of 700 mPa·s (23° C.). Component (B) used was a dimethylpolysiloxane containing hydrolyzable groups, represented by the structural formula below.

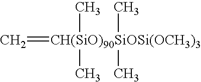

To components (A) and (B) were added 600 parts of spherical aluminum oxide powder AS-30 having a mean particle size of 16 μm (trade name, Showa Denko K.K.) and 300 parts of aluminum oxide powder AL-47-1 having a mean particle size of 1 μm (trade name, Showa Denko K.K.) as component (C). They were mixed at room temperature for 20 minutes on a Shinagawa mixer. This mixture was combined with 16 parts of phenyltri(isopropenyloxy)silane as component (D), 0.8 part of 1,1,3,3-tetramethyl-2-[3-(trimethoxysilyl)propyl]guanidine-siloxane as a curing catalyst, and 1 part of 3-aminopropyltriethoxysilane as an adhesive aid in an anhydrous state. This was followed by deaerating/mixing treatment for 20 minutes, obtaining a composition. The amounts of components (A) and (B) used are shown in Table 2.

The low-viscosity, heat conductive silicone rubber compositions prepared as above were cured at 23±2° C. and 50±5% RH for 7 days into sheets of 6 mm thick, which were measured for hardness using a Durometer type A hardness meter.

Separately, the compositions were cured at 23±2° C. and 50±5% RH for 14 days into blocks of 12 mm thick. They were measured for thermal conductivity using a thermal conductivity meter Kemtherm QTM-D3 (quick thermal conductivity meter by Kyoto Electronic Industry K.K.). To examine storage stability, 100 g of each composition sample was contained in a glass bottle where it was allowed to stand at 23° C. for 1,000 hours. The sample was rated NG when component (C) settled out and OK when no settlement was observed.

The results are shown in Table 2.

TABLE 2

| | | | | | Comparative | |
|---|---|---|---|---|---|---|
| | | Example | | | Example | |
| | | 4 | 5 | 6 | 3 | 4 |
| Compo- | Component A | 95 | 90 | 70 | 50 | 100 |
| nents | Component B | 5 | 10 | 30 | 50 | 0 |
| (pbw) | Component C | 900 | 900 | 900 | 900 | 900 |
| | Component D | 16 | 16 | 16 | 16 | 16 |
| | Curing catalyst | 0.8 | 0.8 | 0.8 | 0.8 | 0.8 |
| | Adhesive aid | 1 | 1 | 1 | 1 | 1 |
| Prop- | Viscosity | 140 | 130 | 98 | 80 | 360 |
| erties | (Pa · s) | | | | | |
| | Hardness | 87 | 92 | 88 | 80 | 90 |
| | (Durometer | | | | | |
| | type A) | | | | | |
| | Heat | 2.3 | 2.3 | 2.4 | 2.4 | 2.4 |
| | conductivity | | | | | |
| | (W/m · K) | | | | | |

| | | | | | |
|---|---|---|---|---|---|
| Storage stability | OK | OK | OK | NG | OK |

The results in Table 2 indicate that the addition of component (B) enables a viscosity reduction, ensuring a composition which is flowable and easy to work.

### Examples 7-9 & Comparative Examples 5-6

Component (A) used was a dimethylpolysiloxane capped with trimethoxy groups at both ends of its molecular chain, having a viscosity of 900 mPa·s (23° C.). Component (B) used was a dimethylpolysiloxane containing hydrolyzable groups, represented by the structural formula below.

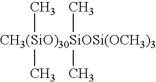

To components (A) and (B) were added 600 parts of spherical aluminum oxide powder AS-30 having a mean particle size of 16 μm (trade name, Showa Denko K.K.) and 300 parts of aluminum oxide powder AL-47-1 having a mean particle size of 1 μm (trade name, Showa Denko K.K.) as component (C). They were mixed at room temperature for 20 minutes on a Shinagawa mixer. This mixture was combined with 7 parts of methyltrimethoxysilane as component (D), 2 parts of titanium chelate catalyst Orgatix TC-750 (trade name, Matsumoto Trading Co., Ltd.) as a curing catalyst, and 0.2 part of 3-aminopropyltriethoxysilane as an adhesive aid in an anhydrous state. This was followed by deaerating/mixing treatment for 20 minutes, obtaining a composition. The amounts of components (A) and (B) used are shown in Table 3.

The low-viscosity, heat conductive silicone rubber compositions prepared as above were cured at 23±2° C. and 50±5% RH for 7 days into sheets of 6 mm thick. They were measured for hardness using a Durometer type A hardness meter.

Separately, the compositions were cured at 23±2° C. and 50±5% RH for 14 days into blocks of 12 mm thick, which were measured for thermal conductivity using a thermal conductivity meter Kemtherm QTM-D3 (quick thermal conductivity meter by Kyoto Electronic Industry K.K.). To examine storage stability, 100 g of each composition sample was contained in a glass bottle where it was allowed to stand at 23° C. for 1,000 hours. The sample was rated NG when component (C) settled out and OK when no settlement was observed.

The results are shown in Table 3.

TABLE 3

| | | | | | Comparative | |
|---|---|---|---|---|---|---|
| | | Example | | | Example | |
| | | 7 | 8 | 9 | 5 | 6 |
| Compo- | Component A | 95 | 90 | 70 | 50 | 100 |
| nents | Component B | 5 | 10 | 30 | 50 | 0 |
| (pbw) | Component C | 900 | 900 | 900 | 900 | 900 |
| | Component D | 7 | 7 | 7 | 7 | 7 |
| | Curing catalyst | 2 | 2 | 2 | 2 | 2 |
| | Adhesive aid | 0.2 | 0.2 | 0.2 | 0.2 | 0.2 |
| Prop- | Viscosity | 130 | 110 | 92 | 80 | 460 |
| erties | (Pa · s) | | | | | |
| | Hardness | 88 | 89 | 85 | 80 | 88 |
| | (Durometer | | | | | |
| | type A) | | | | | |
| | Heat | 2.5 | 2.5 | 2.4 | 2.4 | 2.5 |
| | conductivity | | | | | |
| | (W/m · K) | | | | | |

| | | | | | |
|---|---|---|---|---|---|
| Storage stability | OK | OK | OK | NG | OK |

The results in Table 3 indicate that the addition of component (B) enables a viscosity reduction, ensuring a composition which is flowable and easy to work.

The RTV heat conductive silicone rubber composition of the invention eliminates the drawbacks of the prior art, experiences a minimized viscosity increase even when loaded with a large amount of heat conductive filler, has good potting, coating and sealing properties, and is suited for use in one package form.

Japanese Patent Application No. 2003-155286 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A RTV heat conductive silicone rubber composition comprising
(A) 60 to 99 parts by weight of an organopolysiloxane of the general formula (1): 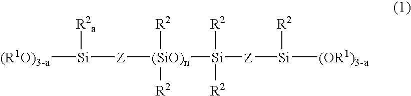
wherein R¹ is hydrogen or a substituted or unsubstituted monovalent hydrocarbon group, R² is a substituted or unsubstituted monovalent hydrocarbon group, Z is an oxygen atom or a divalent hydrocarbon group, a is 0, 1 or 2, and n is an integer of at least 10,
(B) 1 to 40 parts by weight of a hydrolyzable group-containing organopolysiloxane of the general formula (2): 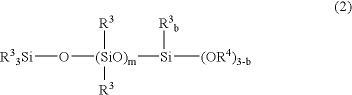
wherein R³ is a substituted or unsubstituted monovalent hydrocarbon group, R⁴ is hydrogen or a substituted or unsubstituted monovalent hydrocarbon group, b is 0, 1 or 2, and m is an integer of 5 to 200, the sum of components (A) and (B) being 100 parts by weight,
(C) 100 to 4,000 parts by weight of a heat conductive filler, and
(D) 1 to 50 parts by weight of an organosilicon compound of the formula: R⁵_{c}SiX_{4-c} wherein R⁵ is a substituted or unsubstituted monovalent hydrocarbon group, X is a hydrolyzable group, and c is 0, 1 or 2, or a partial hydrolytic condensate thereof.

2. The composition of claim 1, wherein R³ in formula (2) is methyl group, vinyl group or phenyl group, and R⁴ in formula (2) is methyl group or ethyl group.

3. The composition of claim 1, wherein the heat conductive filler (C) comprises at least one member selected from the group consisting of inorganic powders such as aluminum oxide, zinc oxide, ground quartz, silicon carbide, silicon nitride, magnesium oxide, aluminum nitride, boron nitride and graphite, and metal powders such as aluminum, copper, silver, nickel, iron and stainless steel.

4. The composition of claim 3, wherein the heat conductive filler (C) comprises at least one member selected from the group consisting of aluminum oxide, aluminum nitride and boron nitride.

5. The composition of claim 1, which is of one package type.
